(19) United States
(12) Patent Application Publication
(10) Pub. No.: US 2006/0063589 A1
(43) Pub. Date: Mar. 23, 2006

(54) Method and system for providing a personal message relating to a personalized item that carries on a surface a personalized optical code

(75) Inventor: William Chong, Burnaby (CA)

Correspondence Address: HARRINGTON & SMITH, LLP, 4 RESEARCH DRIVE, SHELTON, CT, 06484-6212, US

(73) Assignee: NOKIA CORPORATION

(21) Appl. No.: 10/944,632

(22) Filed: Sep. 17, 2004

(51) Int. Cl. A63F 13/00

(52) U.S. Cl. 463/29

(57) ABSTRACT

A method and system for providing a user-dependent message relating to a personalized item, wherein the personalized item carries on a surface a personalized optical code that encodes user-dependent information. The method comprises: using an optical device to read the personalized optical code; using the isolated personalized optical code to determine user-dependent content relating to the item; and displaying at the telecommunications device the user-dependent content. In an embodiment, the personalized item is a gaming ticket, such as a lottery ticket, that carries on a surface an optical code that encodes a choice or choices made by the user participating in the game and the user-dependent content relating to the item identifies whether the personalized item is a winning gaming ticket.

### FIELD OF THE INVENTION

Embodiments of the present invention relate to a method or system for providing a personal message relating to a personalized item, wherein the personalized item carries on a surface a personalized optical code that encodes user-dependent information. In particular, embodiments relate to a method or system in which the personalized item is a gaming ticket, such as a lottery ticket, the optical code encodes a choice or choices made by a player participating in the game and the user-dependent content relating to the item identifies whether the personalized item is a winning gaming ticket.

### BACKGROUND TO THE INVENTION

U.S. Pat. No. 5,933,829 (NeoMedia Technologies, Inc) describes the encoding of an URL within a 2D barcode, such as that disclosed in U.S. Pat. No. 5,304,786. The barcode is then printed onto a document which can be distributed. When a barcode reader, such as that described in U.S. Pat. No. 5,448,050, subsequently reads the barcode, a web browser application is automatically launched by a client computer attached to the barcode reader to access the URL encoded within the barcode. As a result, the user may automatically access a Web site to obtain a computer file without having to enter the URL by a keyboard, thus eliminating all chances of error due to manual data input

A disadvantage with this system is that it requires a barcode reader and computer combination to read the barcode and such a combination is not easily portable. It would be desirable to simplify the system so that it is portable and more conveniently used.

However, on Apr. 27, 2004, Neomedia made a press announcement concerning the launch of PaperClick for Nokia 2650 and 3660 Camera Cell Phones. This would make it possible to take a picture of a UPC or EAN product code on a product, such as a can or bottle of soda, and then go straight to the targeted web-site.

Another disadvantage with the system is that after it accesses a web-site, a user may be required to enter data at the web-site or browse the web-site to obtain the desired service or information. This could act as a disincentive against the use of the technology as the desired service is not immediately obtainable or because data must be entered. It would be desirable to provide a system which also tailors the service provided to a particular user without the use having to manually input data.

### BRIEF DESCRIPTION OF THE INVENTION

According to one embodiment of the invention there is provided a method of providing a user-dependent message relating to a personalized item, wherein the personalized item carries on a surface a personalized optical code that encodes user-dependent information, the method comprising: an optical device for reading the optical code; b) using the isolated personalized optical code to determine user-dependent content relating to the item; and c) displaying at the telecommunications device the user-dependent content.

The method can therefore provide a personalized service relating to the item without the user having to manually input data.

The method is particularly suitable for checking whether a gaming ticket is a winning gaming ticket. In this scenario, the personalized item is a gaming ticket, the optical code encodes a choice or choices made by a player participating in the game and the user-dependent content relating to the item identifies whether the personalized item is a winning gaming ticket.

A user of the telecommunications device can therefore conveniently and remotely check whether a gaming ticket is a winning ticket.

According to another embodiment of the invention there is provided a method of determining whether a gaming ticket that records a choice or choices made by a player is a winning ticket, wherein the gaming ticket carries on a surface an optical code that encodes the choice or choices made by the player, the method comprising: a) using an optical device to read the optical code; b) using the isolated optical code to determine whether the gaming ticket is a winning ticket; and c) indicating on a display of the telecommunications device at least whether the gaming ticket is a winning ticket.

According to another embodiment of the invention there is provided a system for determining whether a gaming ticket that records a choice or choices made by the player is a winning ticket, wherein the gaming ticket carries on a surface an optical code that encodes the choice or choices made by the player, the system comprising: a telecommunications device comprising: an optical device for reading the optical code; a display for indicating at least whether the gaming ticket is a winning ticket; and a radio transceiver for communication with a remote server, and a server for storing game data that records the winning choice(s) of a game comprising: an input/output interface for communication with the telecommunications device, the system further comprising: image processing means for processing the captured image to isolate the optical code from the image; and determining means for using the read optical code and the game data to determine whether the gaming ticket is a winning ticket.

According to another embodiment of the invention there is provided a telecommunications device for determining whether a gaming ticket that records a choice or choices made by the player is a winning ticket, wherein the gaming ticket carries on a surface an optical code that encodes the choice or choices made by the player, the device comprising: an optical device for reading the optical code; a display for indicating at least whether the gaming ticket is a winning ticket; a radio transceiver for communicating with a remote server; image processing means for processing the captured image to isolate the optical code from the image; and determining means for using the read optical code and game data received from the remote server to determine whether the gaming ticket is a winning ticket.

According to another embodiment of the invention there is provided a computer readable medium embodying a computer program, which when loaded into a processor provides: image processing means for processing an image of a gaming ticket captured by a digital camera to isolate an optical code from the image; decoding means for decoding the optical code to identify a choice or choices made by the player and encoded in the optical code of the gaming ticket; and comparison means for comparing winning choices of the game recorded by game data with the identified choices of the player and thereby determining whether the gaming ticket is a winning ticket.

The optical device may, for example, be a digital camera or an optical scanner.

### BRIEF DESCRIPTION OF THE DRAWINGS

For a better understanding of the present invention reference will now be made by way of example only to the accompanying drawings in which:

FIG. 1 illustrates a system for determining whether a gaming ticket 2 that records a choice or choices made by the player is a winning ticket;

FIGS. 2A, 2B and 2C illustrate first, second and third embodiments of the system 1; and

FIGS. 3A, 3B and 3C illustrate process flows corresponding to the first, second and third embodiments.

### DETAILED DESCRIPTION OF EMBODIMENTS OF THE INVENTION

The following paragraphs describe various embodiments of a method that provides a user-dependent message relating to a personalized item, where the personalized item carries on a surface a personalized optical code that encodes user-dependent information. The method comprises: a) capturing an image of the personalized optical code using a digital camera of a telecommunication device; b) processing the captured image to isolate the personalized optical code from the image; c) using the isolated personalized optical code to determine user-dependent content relating to the item; and d) displaying at the telecommunications device the user-dependent content. Step c) may comprise: (i) decoding the optical code to obtain personalized data identifying a choice or choices made by the user; and (ii) using the identity of the choice(s) made to determine the user-dependent content.

In the following illustrative embodiments, the personalized item is a gaming ticket that carries on a surface an optical code that encodes a choice or choices made by a player participating in the game and the user-dependent content relating to the item identifies whether the personalized item is a winning gaming ticket. However, the invention is not limited to such embodiments.

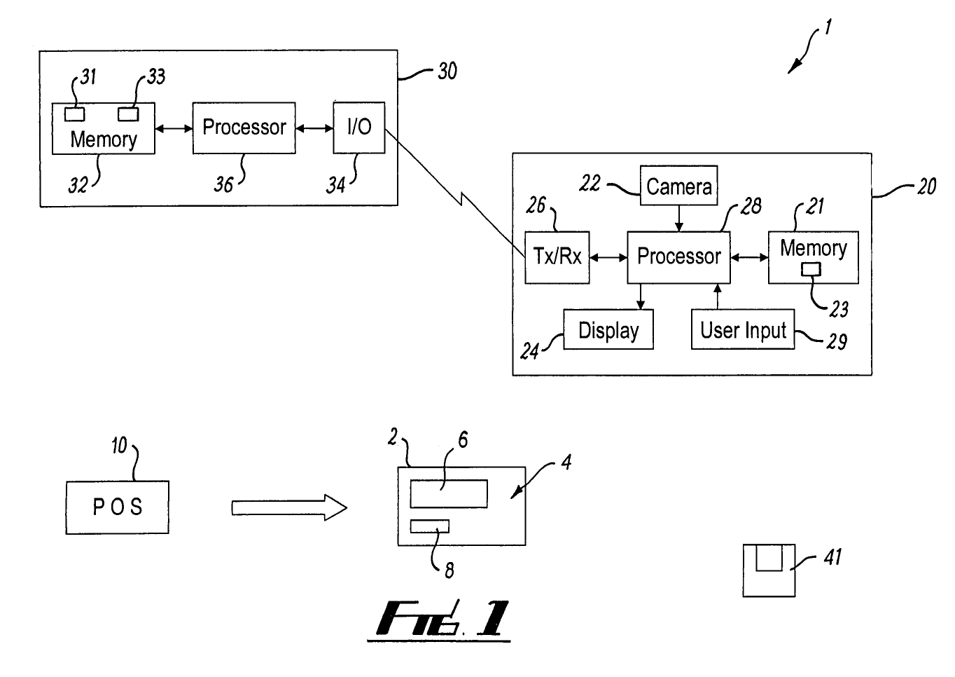

FIG. 1 illustrates a system 1 for determining whether a gaming ticket 2 that records a choice or choices made by the player is a winning ticket.

The system 1 comprises a point of sale device 10 for issuing the gaming ticket 2, a telecommunications device 20 and a server 30. The telecommunications device 20 and the server 30, in combination, determine whether the gaming ticket 2 is a winning ticket.

The gaming ticket 2 has a surface 4 that carries human-readable information 6 and a machine readable optical code 8.

The human readable information 6 typically includes information that identifies the game being played, the choice or choices made by a player in the game and perhaps other information that is important to the game.

For example, if the gaming ticket 2 is a ticket for a lottery, the human-readable information will typically identify the lottery by type e.g. New York State lottery, and by date and also identify the numbers chosen by the player playing the lottery. It may also record where and when the gaming ticket 2 was issued.

As another example, if the gaming ticket 2 is a ticket that records a bet on a horse race, the human-readable information will typically identify the race by location and by time and date and also identify the horse(s) chosen, the type of bet, the odds given and the amount wagered. It may also record where and when the gaming ticket 2 was issued.

The optical code 8 is typically a series of symbols located at a particular position on the surface 4. The symbols may, for example, be a series of parallel lines of different width as in a one-dimensional barcode or a matrix array with different elements of the array blackened out as in a two-dimensional barcode. The optical code 8 may alternatively be hidden within other images on the gaming ticket 2 using stenographics.

The optical code 8 encodes game information that typically includes some or all of the human-readable information 6 and, perhaps some additional information such as an address of a remote server 30 that can be accessed to determine if the gaming ticket is a winning ticket. The address may be in the form of a URL.

The human-readable information 6 may be encrypted before it is encoded to form the optical code 8. The optical code 8 can, in this situation, be used by the authority controlling the game to verify that the human-readable information 4 has not been tampered with. If the human-readable information 6 is encrypted before it is encoded to form the optical code 8, the optical code 8 may be referred to as a secured optical code 8. If the human-readable information 6 is not encrypted before it is encoded to form the optical code 8, the optical code 8 may be referred to as an unsecured optical code 8.

The point of sale device 10 issues the gaming ticket 2 by printing some or all of the human-readable information 6 and the optical code 8 onto the surface 4 of a blank gaming ticket. The blank gaming ticket may have some pre-printed information on it. The point of sale device 10 encodes the game information to form optical code data which is used to print the optical code 8.

The server 30 comprises; a memory 32, an input/output interface 34 and a processor 36 that is connected to read from and write to the memory 32 and to provide data to and receive data from the input/output interface 34.

The input/output interface 34 is used for communication with the telecommunications device 20. The input/output interface 34 may, for example, be a radio transceiver that communicates directly with the radio transceiver 26 of the telecommunications device 20 or it may, for example, be a network adapter that is used to communicate with the telecommunications device 20 via a network that may include a cellular telecommunications network and the Internet.

The memory 32 stores game data 31 that records the winning choice(s) of one or more games. The game data is updated whenever a game ends to record the winning choices for that game.

The memory 32 also stores computer program instructions 33 that control the operation of the server 30 when loaded into the processor 36. The computer program instructions 33 may arrive at the server 30 via a computer readable medium 41 such as a computer program product, a memory device or a record medium such as a CD-ROM or DVD.

The telecommunications device 20 is, in this example, a hand-portable electronic device comprising: a digital camera 22; a display 24 for presenting information to a user of the device 20; a radio transceiver 26; a processor 28; a memory 21; and a user input device 29 such as a keypad or touch screen.

The processor 28 is connected to write to and read from the memory 21 and to provide data to and receive data from the radio transceiver 26. The processor also receives inputs from the camera 22 and user input device 29 and provides an output to the display 24.

The digital camera 22 may be part of a module attached to the telecommunications device 20 or integrated into the body of the telecommunications device 20. The digital camera 22 is suitable for taking photographs when the telecommunications device is used as a camera. It is also suitable for capturing an image of gaming ticket 2 surface 4, including the optical code 8, from a distance of several inches from the surface 4. The image is a normal digital photograph.

The radio transceiver 26 is for communication with the remote server 30. Typically, the telecommunications device is a mobile cellular telephone and the radio transceiver 26 is a cellular radio transceiver for communicating in a cellular radio telecommunications network. Alternatively, the radio transceiver may be used to form a local ad-hoc network e.g. WLAN or Bluetooth.

The memory 21 stores computer program instructions 23 that control the operation of the telecommunications device 20 when loaded into the processor 28. The computer program instructions 23 may arrive at the device 20 via a computer readable medium 41 such as a computer program product, a memory device or a record medium such as a CD-ROM or DVD.

The system 1 additionally comprises: image processing means 40 for processing the image captured by the digital camera 22 and isolating the optical code 8 from the image; decoding means 42 for decoding the optical code 8 to identify the choice(s) made by the player; and comparison means 44 for comparing the winning choices of the game recorded by the game data 33 with the identified choices of the player and thereby determining whether the gaming ticket is a winning ticket. The decoding means 42 and comparison means 44 operate together using the isolated optical code 8 and the game data 33 to determine whether the gaming ticket is a winning ticket.

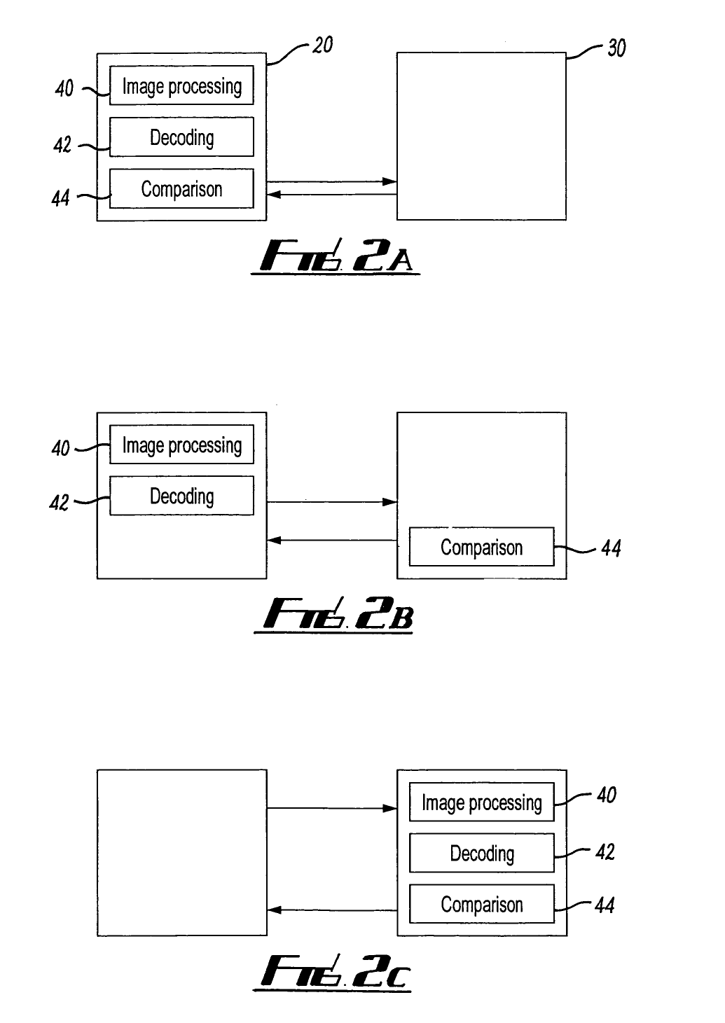

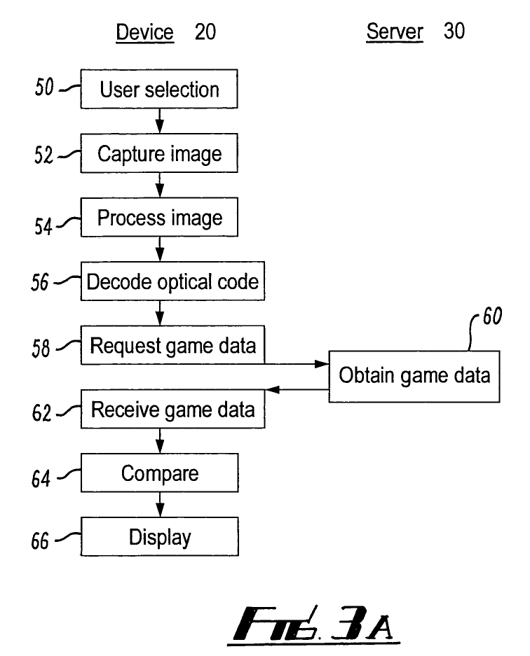

In a first embodiment, illustrated in FIG. 2A the image processing means 40, the decoding means 42 and the comparison means 44 are located within the telecommunications device 20 and are provided by loading the computer program instructions 23 into the processor 28.

This embodiment may be used if the optical code 8 is unsecured. It will not generally be used when the optical code is secured and providing a mechanism for decrypting the encrypted game information may enable unauthorized persons to create correctly encrypted game data, as this would compromise the security of the gaming ticket 2. However if the game data is encrypted using a private key and decrypted using a public key, then this embodiment may be used for secured optical codes. In this embodiment, the device 20 performs most of the processing.

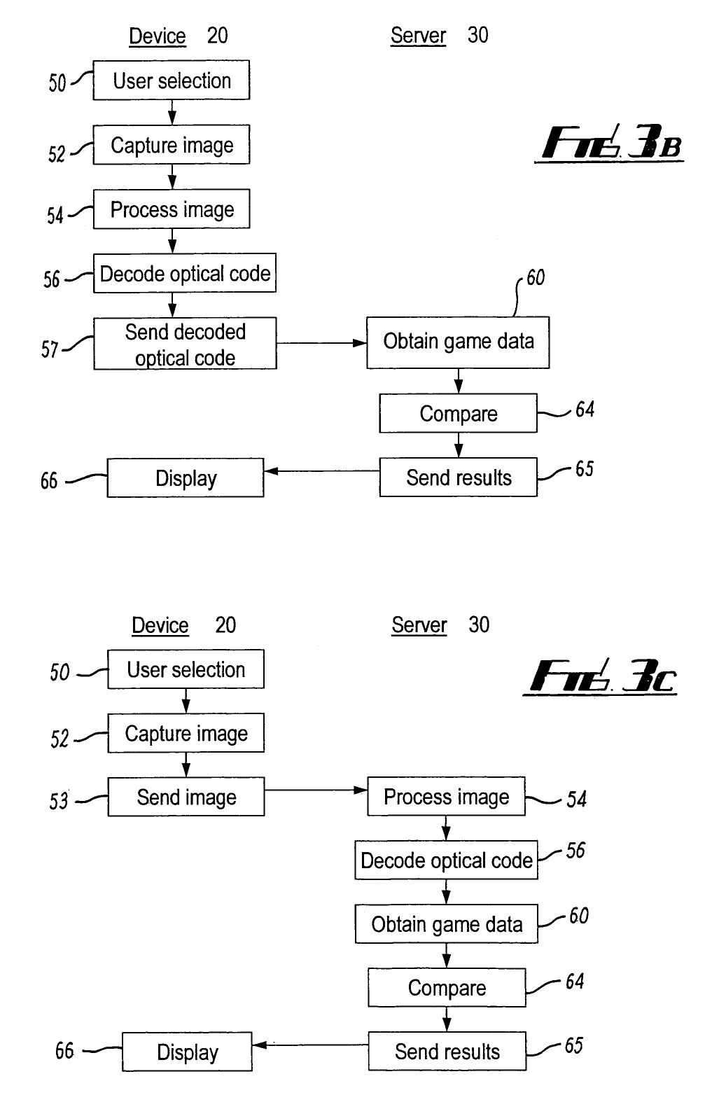

The process followed in this embodiment is illustrated in FIG. 3A. At step 50, a user of the device 20 selects an option from a menu presented on the display 24 of the device 20 e.g. a “scan optical code” option.

Then at step 52, an image of the optical code is captured using the digital camera 22.

Then at step 54, the captured image is automatically processed by the image processing means 40 to isolate the optical code from the image.

Then at step 56, the optical code is automatically decoded by the decoding means 42 to identify the game and the choice or choices made by the player;

Then at step 58, the comparison means 44 automatically sends a request to the server 30 requesting game data 33 for the identified game.

Then at step 60, the server 30 uses the request received from the device 10 to identify the game for which game data is requested. The processor 36 accesses the memory 32 and obtains the game data for the relevant game and sends this game data 33 to the device 10.

Then at step 62, the device 10 receives, in reply to the request, game data 33 that indicates at least the winning choices of the identified game.

Then at step 64, the comparison means 44 automatically compares the received winning choices of the game with the choices of the player and thereby determining whether the gaming ticket is a winning ticket.

Then at step 66, the comparison means 44 automatically controls the display 24 to indicate whether the gaming ticket is a winning ticket and the choice(s) identified by the decoding means 42 on decoding the optical code.

Thus in the combination of steps 56, 58, 62 and 64 the isolated optical code is used to determine whether the gaming ticket is a winning ticket. In steps 58, 62 and 64 the identity of the choice(s) made is used to determine whether the gaming ticket is a winning ticket.

In an alternative implementation of the first embodiment, the device 20 makes a telephone call to the server 30, which is dedicated to a particular lottery and downloads the game results from the server 30. Thus the game results are received before the image of the lottery ticket is captured. The method step 56 is consequently automatically followed by step 64.

In a second embodiment, illustrated in FIG. 2B the image processing means 40 and the decoding means 42 are located within the telecommunications device 20 and are provided by loading the computer program instructions 23 into the processor 28. The comparison means 44 are located within the server 30 and are provided by loading the computer program instructions 33 into the processor 36. This embodiment reduces the processing burden placed upon the device 20.

The process followed in this embodiment is illustrated in FIG. 3B, which is similar to FIG. 3A except that: After step 56, at step 57, the decoding means 42 in the device 10 sends the decoded optical code to the server 30. This identifies the game and the choice or choices made by the player. Then at step 60, the server 30 uses the decoded optical code to identify the game. The processor 36 accesses the memory 32 and obtains the game data for the identified game. Then at step 64, the comparison means 44 in the server 30 automatically compares the winning choices of the game with the choices of the player and thereby determines whether the gaming ticket is a winning ticket. Then at step 65, the server 30 sends results data to the device 10 indicating whether the gaming ticket 2 is a winning ticket. Then at step 66, the device 10 automatically controls the display 24 to display the received data which indicates whether the gaming ticket is a winning ticket and the choice(s) identified by the decoding means 42 on decoding the optical code.

In a third embodiment, illustrated in FIG. 2C the image processing means 40, the decoding means 42 and the comparison means 44 are located within the server 30 and are provided by loading the computer program instructions 33 into the processor 36. This embodiment further reduces the processing burden placed upon the mobile device 10.

The process followed in this embodiment is illustrated in FIG. 3C, which is similar to FIG. 3A except that:

After step 52, at step 53, the captured image of the optical code is sent to the server 30. Then at step 54, the captured image is automatically processed by the image processing means 40 in the server to isolate the optical code from the image. Then at step 56, the optical code is automatically decoded by the decoding means 42 in the server to identify the game and the choice or choices made by the player. Then at step 60, the comparison means 44 in the server 30 automatically accesses the memory 32 and obtains the game data for the identified game that indicates at least the winning choices of the identified game. Then at step 64, the comparison means 44 automatically compares the winning choices of the game with the choices of the player and thereby determines whether the gaming ticket is a winning ticket. Then at step 65, the server 30 sends results data to the device 10 indicating whether the gaming ticket 2 is a winning ticket and the choice(s) identified by the decoding means 42 on decoding the optical code 8. Then at step 66, the device 10 automatically controls the display 24 to display the received results data which indicates whether the gaming ticket is a winning ticket and the choice(s) identified by the decoding means 42 on decoding the optical code.

Error correction techniques may be used verify that the results obtained from the decoding step 56 correspond to the game information that was originally encoded. Such error correction techniques are well known to the person of ordinary skill in the art and are not described further here.

The preceding description has described the reading of an optical code 8 using a digital camera. Other embodiments of the invention may read an optical code using a different optical device, the process of the invention after reading the optical code is then as described above. One suitable optical device for reading an optical barcode code is an optical scanner. An optical barcode scanner typically comprises a light transmitter, such as one or more LEDs and a light receiver. Light from the transmitter is directed onto the optical code 8. The detection of variations in the light reflected by the optical code by the receiver allows the optical code to be read.

Although embodiments of the present invention have been described in the preceding paragraphs with reference to various examples, it should be appreciated that modifications to the examples given can be made without departing from the spirit and scope of the invention.

I/we claim:

1. A method of determining whether a gaming ticket that records a choice or choices made by a player in a game is a winning ticket, wherein the gaming ticket carries on a surface an optical code that encodes the choice or choices made by the player, the method comprising:
a) using an optical device to read the optical code;
b) using the optical code to determine whether the gaming ticket is a winning ticket; and
c) indicating on a display of the telecommunications device at least whether the gaming ticket is a winning ticket.

2. A method as claimed in claim 1, wherein step c) comprises:
(i) decoding the optical code to identify the choice or choices made by the player; and
(ii) using the identity of the choice(s) made to determine whether the gaming ticket is a winning ticket;

3. A method as claimed in claim 2, further comprising using error correction techniques to verify that the identified choice(s) correspond to the choice(s) encoded by the optical code.

4. A method as claimed in claim 2, wherein decoding the optical code additionally identifies the game.

5. A method as claimed in claim 2, wherein the step of indicating on a display of the telecommunications device at least whether the gaming ticket is a winning ticket, additionally indicates the choice(s) identified by decoding the optical code.

6. A method as claimed in claim 1, wherein step a) is initiated by a user command and steps b) and c) occur automatically without user intervention.

7. A method as claimed in claim 6, wherein step a) is initiated by selecting an option in a menu presented on the display of a telecommunications device.

8. A method as claimed in claim 1, further comprising, after step a) but before step b), sending the captured image to a remote server where steps b) and c) occur, and, then after step c) but before step d), receiving, at the telecommunications device, a reply that indicates at least whether the gaming ticket is a winning ticket.

9. A method as claimed in claim 1, wherein step a) occurs at a telecommunications device, the method further comprising, after step a) but before step b), sending data defining the optical code to a remote server, and, after step b), receiving, at the telecommunications device, a reply that indicates at least whether the gaming ticket is a winning ticket

10. A method as claimed in claim 9, further comprising using error correction techniques at the telecommunications device to verify that the data sent corresponds to the optical code of the gaming ticket.

11. A method as claimed in claim 1, wherein step a) occurs at a telecommunications device, and the step of using the optical code to determine whether the gaming ticket is a winning ticket occurs at the telecommunications device and comprises:
(i) decoding the optical code to identify the game and the choice or choices made by the player;
(ii) requesting game data from a remote server for the identified game;
(iii) receiving in reply game data that indicates at least the winning choices of the identified game; and
(iv) comparing the received winning choices of the game with the choices of the player and thereby determining whether the gaming ticket is a winning ticket.

12. A method as claimed in claim 11, further comprising using error correction techniques to verify that the identified choice(s) correspond with the encoded choices.

13. A method as claimed in claim 1, wherein the gaming ticket is a lottery ticket and the choices are a series of numbers.

14. A method as claimed in claim 1, wherein the optical device is an optical scanner.

15. A method as claimed in claim 1, wherein the optical device is a digital camera of a telecommunications device, wherein step a) comprises:
i) capturing an image of the optical code using the digital camera of the telecommunication device; and
ii) processing the captured image to determine the optical code.

16. A method as claimed in claim 15, wherein the telecommunications device is a hand-portable electronic device.

17. A method as claimed in claim 16, wherein the telecommunications device is a mobile cellular telephone.

18. A system for determining whether a gaming ticket that records a choice or choices made by the player is a winning ticket, wherein the gaming ticket carries on a surface an optical code that encodes the choice or choices made by the player, the system comprising:
a telecommunications device comprising:
an optical device for reading the optical code;
a display for indicating at least whether the gaming ticket is a winning ticket; and
a radio transceiver for communication with a remote server, and
a server for storing game data that records the winning choice(s) of a game comprising:
an input/output interface for communication with the telecommunications device,
the system further comprising:
determining means for using the read optical code and the game data to determine whether the gaming ticket is a winning ticket.

19. A system as claimed in claim 18, wherein the determining means comprises:
decoding means for decoding the optical code to identify the choice(s) made by the player; and
comparison means for comparing the winning choices of the game recorded by the game data with the identified choices of the player and thereby determining whether the gaming ticket is a winning ticket.

20. A system as claimed in claim 19, wherein the decoding means are located within the server.

21. A system as claimed in claim 19, wherein the decoding means are located within the telecommunications device.

22. A system as claimed in claim 19, wherein the comparison means are located within the server.

23. A system as claimed in claim 19, wherein the comparison means are located within the telecommunications device.

24. A system as claimed in claim 18, wherein the telecommunications device is a hand-portable mobile cellular telephone.

25. A system as claimed in claim 18, wherein the optical device is a digital camera for capturing an image of the optical code.

26. A system as claimed in claim 25, wherein the telecommunications device comprises image processing means for processing the captured image to isolate the optical code from the image.

27. A system as claimed in claim 25, wherein the server comprises image processing means for processing the captured image to isolate the optical code from the image.

28. A system as claimed in claim 18, wherein the optical device is an optical scanner.

29. A telecommunications device for determining whether a gaming ticket that records a choice or choices made by the player is a winning ticket, wherein the gaming ticket carries on a surface an optical code that encodes the choice or choices made by the player, the device comprising:
an optical device for reading the optical code;
a display for indicating at least whether the gaming ticket is a winning ticket;
a radio transceiver for communicating with a remote server; and
determining means for using the read optical code and game data received from the remote server to determine whether the gaming ticket is a winning ticket.

30. A telecommunications device as claimed in claim 29, wherein the optical device is a digital camera for capturing an image of the optical code.

31. A telecommunications device as claimed in claim 30, wherein the telecommunications device further comprises image processing means for processing the captured image to isolate the optical code from the image.

32. A telecommunications device as claimed in claim 29, wherein the optical device is an optical scanner.

33. A computer readable medium embodying a computer program, which when loaded into a processor provides:
image processing means for processing an image of a gaming ticket captured by a digital camera to isolate an optical code from the image;
decoding means for decoding the optical code to identify a choice or choices made by the player and encoded in the optical code of the gaming ticket; and
comparison means for comparing winning choices of the game recorded by game data with the identified choices of the player and thereby determining whether the gaming ticket is a winning ticket.

34. A method of providing a user-dependent message relating to a personalized item, wherein the personalized item carries on a surface a personalized optical code that encodes user-dependent information, the method comprising:
a) using an optical device to read the personalized optical code;
b) using the read personalized optical code to determine user-dependent content relating to the item; and
c) displaying at the telecommunications device the user-dependent content.

35. A method as claimed in claim 34, wherein step b) comprises:
(i) decoding the optical code to obtain personalized data identifying a choice or choices made by the user; and
(ii) using the identity of the choice(s) made to determine the user-dependent content.

36. A method as claimed in claim 34, wherein the personalized item is a gaming ticket that carries on a surface an optical code that encodes a choice or choices made by the user participating in the game and the user-dependent content relating to the item identifies whether the personalized item is a winning gaming ticket.

37. A method as claimed in claim 34, wherein step a) comprises capturing an image of the personalized optical code using a digital camera of a telecommunication device and processing the captured image to isolate the personalized optical code from the image;
